(19) United States
(12) Patent Application Publication
(10) Pub. No.: US 2025/0015257 A1
(43) Pub. Date: Jan. 9, 2025

(54) ELECTROCHEMICAL DEVICE

(71) Applicant: MURATA MANUFACTURING CO., LTD., Kyoto (JP)

(72) Inventor: Keitaro KITADA, Kyoto (JP)

(21) Appl. No.: 18/887,317

(22) Filed: Sep. 17, 2024

Related U.S. Application Data
(63) Continuation of application No. PCT/JP2023/011404, filed on Mar. 23, 2023.

(30) Foreign Application Priority Data
Mar. 30, 2022 (JP) 2022-055419

(51) Int. Cl. H01M 4/131; H01M 4/02; H01M 4/62; H01M 10/052

(52) U.S. Cl. CPC H01M 4/131; H01M 4/625; H01M 10/052; H01M 2004/021

(57) ABSTRACT

An electrochemical device is provided and includes a positive electrode, a negative electrode, a separator, and an electrolyte, and at least one of the positive electrode or the negative electrode includes first active material particles and fibrous carbon, the first active material particles are retained in a bridge structure formed by the fibrous carbon, the separator includes insulating inorganic particles and an inorganic binder that bonds the insulating inorganic particles together, the electrolyte includes a nonaqueous solvent and a supporting salt, the positive electrode, the negative electrode, and the separator are impregnated with the electrolyte, and the separator and at least one of the positive electrode or the negative electrode are bonded together by the inorganic binder.

### CROSS REFERENCE TO RELATED APPLICATIONS

The present application is a continuation of PCT patent application no. PCT/JP2023/011404, filed on Mar. 23, 2023, which claims priority to Japanese patent application no. 2022-055419, filed on Mar. 30, 2022, the entire contents of which are incorporated herein by reference.

### BACKGROUND

The present application relates to an electrochemical device.

A lithium secondary battery is disclosed in which a positive electrode layer, a ceramic separator, and a negative electrode layer form one integrated sintered body plate as a whole.

### SUMMARY

The present application relates to an electrochemical device.

A difference in shrinkage rate during firing of the positive electrode layer, the ceramic separator, and the negative electrode layer may cause a crack or warpage.

The present application, in an embodiment, relates to providing an electrochemical device capable of restraining an electrode layer from cracking during firing.

An electrochemical device of an aspect of the present application includes a positive electrode, a negative electrode, a separator, and an electrolyte, and at least one of the positive electrode or the negative electrode includes first active material particles and fibrous carbon, the first active material particles are retained in a bridge structure formed by the fibrous carbon, the separator includes insulating inorganic particles and an inorganic binder that bonds the insulating inorganic particles together, the electrolyte includes a nonaqueous solvent and a supporting salt, the positive electrode, the negative electrode, and the separator are impregnated with the electrolyte, and the separator and at least one of the positive electrode or the negative electrode are bonded together by the inorganic binder.

According to the electrochemical device of the present application, in an embodiment, an electrode layer can be restrained from cracking during firing.

### BRIEF DESCRIPTION OF THE FIGURES

FIG. 1 is a schematic sectional view illustrating the configuration of a secondary battery according to an embodiment.

FIG. 2 is an explanatory view for explanation of the configuration of a positive electrode.

### DETAILED DESCRIPTION

The electrochemical device of the present application will be described in further detail including with reference to the drawings according to an embodiment. Note that the present application is not limited thereto. Each embodiment is illustrative, and it goes without saying that partial replacement or combination can be performed between configurations shown in different embodiments.

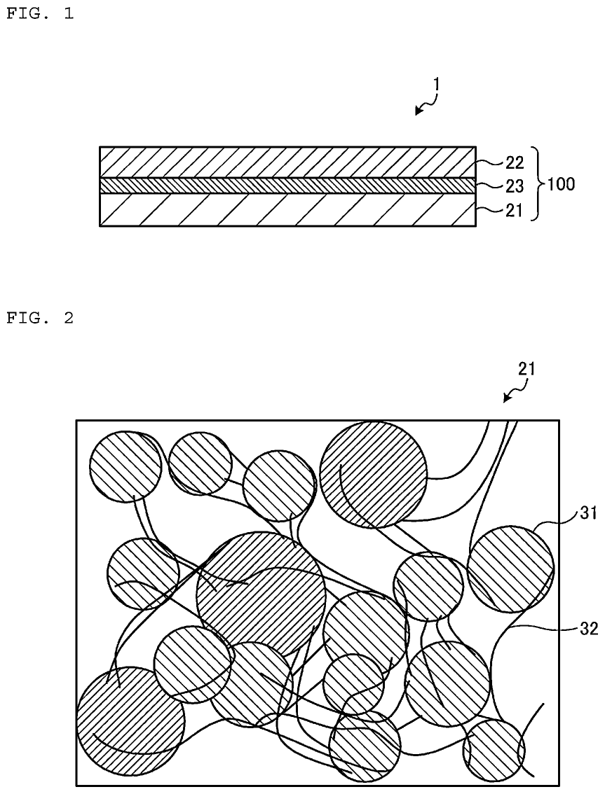

FIG. 1 is a sectional view illustrating the configuration of a secondary battery according to an embodiment. As illustrated in FIG. 1, a secondary battery 1 according to an embodiment includes an electrode laminate 100 in which a positive electrode 21, a negative electrode 22, and a separator 23 are laminated. The positive electrode 21 and the negative electrode 22 are laminated with the separator 23 interposed therebetween. The secondary battery 1 according to an embodiment is a lithium ion secondary battery in which the capacity of the negative electrode 22 is obtained by occlusion and release of lithium (Li).

The positive electrode 21, the negative electrode 22, and the separator 23 included in the electrode laminate 100 are elements formed as an integrated sintered body. The integrated sintered body is a sintered body obtained by laminating and pressure-bonding three or more layers including a positive electrode green sheet that forms the positive electrode 21, a negative electrode green sheet that forms the negative electrode 22, and a separator green sheet that forms the separator 23 to form a green sheet laminate, and firing the green sheet laminate. The organic binder included in each green sheet disappears at the time of firing, and therefore each layer of the positive electrode 21, the negative electrode 22, and the separator 23 after firing does not include an organic binder. A detailed method for manufacturing the electrode laminate 100 will be described below.

FIG. 2 is an explanatory view for explanation of the configuration of a positive electrode. As illustrated in FIG. 2, the positive electrode 21 includes a positive electrode active material 31 (first active material particles) and fibrous carbon 32. The positive electrode active material 31 is a positive electrode material capable of occluding and releasing lithium ions, and for example, a lithium-cobalt composite oxide (hereinafter, referred to as LCO) is used. The LCO is a lithium-transition metal composite oxide having a composition of the general formula LiₓCo_{(1-y)}M_{y}O₍₂₋ₐ₎X_{b} (wherein M represents at least one element selected from Ni, Mn, Mg, Ba, Al, B, Ti, V, Cr, Fe, Cu, Zn, Zr, Mo, Sn, Ca, Sr, W, Na, K, Nb, Ta, and rare earth elements, X represents at least one element selected from F, Cl, Br, I, P, S, and Si, x satisfies 0.9≤x≤1.1, y satisfies 0≤y≤0.5, a satisfies −0.1≤a≤0.2, and b satisfies 0≤b≤0.1). As the positive electrode active material 31, another lithium composite oxide can be used without being limited to the LCO, and examples of a usable material include lithium-nickel composite oxides, lithium-manganese composite oxides, lithium-iron composite phosphorus oxides, lithium-manganese composite phosphorus oxides, and mixtures of the materials described above.

The fibrous carbon 32 is disposed between a plurality of positive electrode active materials 31, has a smaller diameter than each positive electrode active material 31, and has a length longer than the diameter of each positive electrode active material 31. The fibrous carbon 32 forms a bridge structure so as to connect the plurality of positive electrode active materials 31. At least a part of the fibrous carbon 32 extends along the surfaces of the positive electrode active materials 31. In other words, the plurality of positive electrode active materials 31 are retained in the bridge structure of the fibrous carbon 32. As the material of the fibrous carbon 32, for example, a carbon nanotube (CNT) is used.

The negative electrode 22 includes a negative electrode active material (second active material particles). As the negative electrode active material, for example, a lithium-titanium composite oxide (hereinafter, referred to as LTO) is used. The LTO is a metal oxide represented by the general formula LiₓTi_{y}O₄ (0.8≤x≤1.4, 1.6≤y≤2.2). The negative electrode active material is not limited to the LTO, and another material can be used that includes lithium ions that can be inserted and extracted. Examples of a usable material include lithium-niobium composite oxides, lithium-tungsten composite oxides, graphite, hard carbon, soft carbon, silicon, silicon alloys, silicon oxides, tin, tin alloys, tin oxides, and mixtures of the materials described above.

The negative electrode 22 does not include the fibrous carbon 32. That is, the negative electrode 22 is formed by bonding the negative electrode active materials (LTOs) together. However, the negative electrode 22 may include the negative electrode active material and the fibrous carbon 32, as in the case of the positive electrode 21. Alternatively, a configuration may be adopted in which the negative electrode 22 includes the negative electrode active material and the fibrous carbon 32 and the positive electrode 21 does not include the fibrous carbon 32. In the negative electrode 22, active materials may be bonded together with an inorganic binder. The inorganic binder is, for example, a non-ionic conductive and insulating glass frit. The inorganic binder included in the negative electrode 22 may have ion conductivity or electron conductivity.

The separator 23 separates the positive electrode 21 and the negative electrode 22, and allows lithium ions to pass while preventing a short circuit of current caused by contact of both electrodes. In the present embodiment, the separator 23 includes insulating inorganic particles and an inorganic binder that bonds the inorganic particles together. The insulating inorganic particles include, for example, a ceramic material such as aluminum oxide (Al₂O₃). The inorganic binder is, for example, a non-ionic conductive and insulating glass frit. The inorganic particles in the separator 23 are not limited to aluminum oxide, and another ceramic material can be used such as boehmite or magnesium oxide.

As illustrated in FIG. 1, the positive electrode 21 and the separator 23 are provided in direct contact with each other, and so are the negative electrode 22 and the separator 23. As described above, the electrode laminate 100 is an integrated sintered body, and each pair of layers of the positive electrode 21 and the separator 23, and the negative electrode 22 and the separator 23 are bonded together by the inorganic binder included in the separator 23 or the inorganic binder included in the positive electrode 21 and the negative electrode 22.

The electrode laminate 100 in which the positive electrode 21, the negative electrode 22, and the separator 23 are laminated is housed in a case (exterior body) (not illustrated) and sealed in the case. The positive electrodes 21, the negative electrodes 22, and the separators 23 are impregnated with an electrolyte. The electrolyte includes a nonaqueous solvent and a supporting salt (lithium salt). The nonaqueous solvent includes, for example, a lactone-based solvent such as γ-butyrolactone, γ-valerolactone, δ-valerolactone, or ε-caprolactone, a carbonate ester-based solvent such as ethylene carbonate, propylene carbonate, butylene carbonate, vinylene carbonate, dimethyl carbonate, ethyl methyl carbonate, or diethyl carbonate, an ether-based solvent such as 1,2-dimethoxyethane, 1-ethoxy-2-methoxyethane, 1,2-diethoxyethane, tetrahydrofuran, or 2-methyltetrahydrofuran, a carboxylate ester-based solvent such as propyl acetate, ethyl acetate, propyl propionate, or ethyl propionate, a nitrile-based solvent such as acetonitrile, a sulfolane-based solvent, a phosphoric acid, a phosphoric acid ester solvent, or a pyrrolidone.

Examples of the supporting salt include lithium salts such as lithium perchlorate (LiClO₄), lithium hexafluorophosphate (LiPF₆), lithium tetrafluoroborate (LiBF₄), lithium bis (trifluoromethanesulfonyl) imide (LiN(SO₂CF₃)₂), lithium bis (pentafluoroethanesulfonyl) imide (LiN(SO₂C₂F₅)₂), lithium bis (fluorosulfonyl) imide (LiFSI), lithium bis (trifluoromethanesulfonyl) imide (LiTFSI), and lithium hexafluoroarsenate (LiAsF₆).

As described above, at least one of the positive electrode 21 or the negative electrode 22, or in the present embodiment, the positive electrode 21 includes the positive electrode active material 31 and the fibrous carbon 32, and the positive electrode active material 31 is retained in the bridge structure formed by the fibrous carbon 32. As a result, when stress is caused by a difference in shrinkage rate between the positive electrode 21 and the negative electrode 22, between the positive electrode 21 and the separator 23, or between the negative electrode 22 and the separator 23 during firing of the electrode laminate 100, the fibrous carbon 32 deforms to change the curvature, or the contact points in the fibrous carbon 32 move. Thus, the stress caused by a difference in shrinkage rate between the layers is alleviated, and the positive electrode 21 and the negative electrode 22 are restrained from cracking or warping during firing.

Furthermore, the positive electrode active material 31 is retained in the bridge structure of the fibrous carbon 32, and therefore necking (bonding) between the positive electrode active materials 31 is suppressed. As a result, an increase in brittleness of the positive electrode 21 due to the fibrous carbon 32 is suppressed, and an increase in resistance of the positive electrode 21 is suppressed.

More specifically, the positive electrode active material 31 and the fibrous carbon 32 of the positive electrode 21 satisfy Formulas (1) and (2) described below.

$$ln ( a / b ) > - 116.12 \times c + 7.3384 \qquad ( 1 )$$

$$c > 0.2 \qquad ( 2 )$$

a represents the particle size (D50) of the positive electrode active material 31, b represents the diameter of the fibrous carbon 32, and c represents the volume content of the fibrous carbon 32. The volume content represents the rate of the volume of the fibrous carbon 32 in the total volume of the positive electrode 21 including the positive electrode active material 31 and the fibrous carbon 32.

Note that the particle size (D50) of the positive electrode active material 31 was measured with a method using a laser diffraction particle size distribution measuring device.

That is, if the ratio of the particle size (a) of the positive electrode active material 31 to the diameter (b) of the fibrous carbon 32 is large, the fibrous carbon 32 is formed in a shape thinner than the diameter of the positive electrode active material 31, and is disposed along the surface of the positive electrode active material 31. As a result, an improvement is achieved in the retention of the positive electrode active material 31 in the bridge structure formed by the fibrous carbon 32, and the contact between the positive electrode active materials 31 is reduced, so that necking during firing is prevented. Furthermore, also in a case where the volume content (c) of the fibrous carbon 32 is large, an improvement is achieved in the retention of the positive electrode active material 31 in the bridge structure formed by the fibrous carbon 32, and the contact between the positive electrode active materials 31 is reduced, so that necking during firing is prevented.

Note that the constant A (−116.12) and the constant B (7.3384) in Formula (1) and the reference value 0.2 in the right side of Formula (2) have been experimentally obtained, and details will be described in Examples, Table 1, and Table 2 below.

Next, a method for manufacturing the secondary battery 1 including the electrode laminate 100 will be described. First, in a preliminary study, the particle size is adjusted by pulverizing an LCO powder, which is a raw material powder of the positive electrode 21, with a planetary ball mill. An LCO powder (manufactured by Umicore, D50=8.7 μm), and in addition, N-methyl-2-pyrrolidone (NMP) as a solvent and Zro beads ((1 mm) as media were added into a planetary ball mill, and the mixture was treated for 30 minutes, 24 hours, and 48 hours. The particle size (D50) of the LCO was measured for each treatment time described above, and as a result, the particle size was 4.6 μm, 1.1 μm, and 0.56 μm, respectively.

In a 150 mL plastic container, 17.5 g of an LTO powder (manufactured by ISHIHARA SANGYO KAISHA, LTD., D50=8.7 μm) as a raw material powder of the negative electrode 22, 3.5 g of polyvinyl butyral (PVB, manufactured by SEKISUI CHEMICAL CO., LTD., product number BM-2) as a binder, 0.85 g of DOP (bis (2-ethylhexyl) phthalate, manufactured by Tokyo Chemical Industry Co., Ltd.) as a plasticizer, and 15 g of NMP as a solvent were weighed out and mixed with a rotation-revolution mixer to obtain an LTO slurry.

The LTO slurry was applied onto a PET film having a release agent on one side (manufactured by TOYOBO Co., Ltd., product number E7007) with an applicator and an automatic coater, and dried in an oven at 80° C. for 40 minutes, and subsequently at 120° C. for 20 minutes. The dried coating film was peeled off from the PET film, and punched out with a 15 mm diameter punching machine to form a negative electrode green sheet. At this time, the coating weight was 5.0 mg-LTO/cm².

In a 150 mL plastic container, 39.1 g of spherical alumina particles (manufactured by Showa Denko K.K., product number CB-P05) as a raw material powder of the separator 23, 7.5 g of a glass frit (manufactured by Okamoto Glass Co., Ltd., product number PG51) as an inorganic binder, 7.0 g of PVB (manufactured by SEKISUI CHEMICAL CO., LTD., product number BM-2) as a binder, 1.7 g of DOP (manufactured by Tokyo Chemical Industry Co., Ltd.) as a plasticizer, and 23 g of NMP as a solvent were weighed out and mixed with a rotation-revolution mixer to obtain an alumina slurry.

The alumina slurry was applied onto a PET film having a release agent on one side (manufactured by TOYOBO Co., Ltd., product number E7007) with an applicator and an automatic coater, and dried in an oven at 80° C. for 40 minutes, and subsequently at 120° C. for 20 minutes. The dried coating film was peeled off from the PET film, and punched out with a 15 mm diameter punching machine to form a separator green sheet. At this time, the coating weight was 7.0 mg/cm².

In a 150 mL plastic container, 23.5 g of an LCO powder (manufactured by Umicore, D50=8.7 μm) as a raw material powder of the positive electrode 21, 5.88 g of an NMP dispersion in which 0.4 wt % of single wall carbon nanotubes (SWCNTs) as the fibrous carbon 32 were dispersed (SWCNT diameter: 1.6 nm), 0.875 g of PVB (manufactured by SEKISUI CHEMICAL CO., LTD., product number BM-2) as a binder, 0.2125g of DOP (manufactured by Tokyo Chemical Industry Co., Ltd.) as a plasticizer, and 5 g of NMP as a solvent were weighed out and mixed with a rotation-revolution mixer. To the obtained mixture, NMP was further added and the resulting mixture was mixed with a rotation-revolution mixer repeatedly until the mixture had a viscosity appropriate for coating, and thus an LCO slurry was obtained. At this time, assuming that the LCO had a true specific gravity of 5 and CNT had a true specific gravity of 2.1, CNT was contained at a ratio of 0.24 vol % to the LCO.

The LCO slurry was applied onto a PET film having a release agent on one side (manufactured by TOYOBO Co., Ltd., product number E7007) with an applicator and an automatic coater, and dried in an oven at 80° C. for 40 minutes, and subsequently at 120° C. for 20 minutes. The dried coating film was peeled off from the PET film, and punched out with a 15 mm diameter punching machine to form a positive electrode green sheet. At this time, the coating weight was 7.9 mg-LCO/cm².

The green sheets were laminated so that the separator green sheet was interposed between the negative electrode green sheet and the positive electrode green sheet. Uniaxial pressing was performed at 185 MPa for 1 minute with a die heated to 60° C., and the laminated green sheets were pressure-bonded. Thus, a green sheet laminate was obtained in which three layers of the negative electrode green sheet, the positive electrode green sheet, and the separator green sheet were laminated.

The green sheet laminate was sandwiched between porous zirconia setters, degreased in the atmosphere at 400° C. for 4 hours, and then fired in a nitrogen (N₂) atmosphere at 700° C. for 30 minutes. Thus, the organic materials such as the binder and the plasticizer in the green sheets disappeared in the degreasing step, and the positive electrode 21, the separator 23, and the negative electrode 22 were integrally sintered to obtain an electrode sintered body in which an organic material was not included in each layer.

An Au thin film was formed on both surfaces of the laminated sintered body using an Au sputtering device (JFC-1200). Thus, a positive electrode current collector and a negative electrode current collector were formed on the positive electrode 21 and the negative electrode 22, respectively, in the laminated sintered body to obtain a laminated element.

Lithium hexafluorophosphate (LiPF₆) having a lithium salt molar concentration of 1 M was added to propylene carbonate as a nonaqueous solvent, and dissolved by shaking to obtain a nonaqueous solvent electrolytic solution.

The laminated element was impregnated with the nonaqueous solvent electrolytic solution, and the laminated element was sealed in a coin-shaped case (for example, 420 mm, thickness 1.6 mm). Through the steps as described above, for example, a 2016 coin cell can be produced as the secondary battery 1 having the electrode laminate 100.

### EXAMPLES

The present application will be described in further detail according to an embodiment. In Examples and Comparative Examples, evaluation was performed to determine the presence or absence of a crack after firing, and the battery characteristics of a sample having no crack. As the battery characteristics, the capacity test (discharge capacity) and the load characteristic (capacity retention) were evaluated.

In the evaluation of the capacity test, constant current charge was performed at a current density of 160 mA/g-LTO at 2.7 V, and then constant voltage charge was performed at 2.7 V until the current density reached 16 mA/g-LTO to complete charge. Constant current discharge was performed up to 1.8 V at a current value of 160 mA/g-LTO, the capacities obtained in the charge process and the discharge process were regarded as the charge capacity and the discharge capacity, respectively, and the ratio of the discharge capacity to the charge capacity was regarded as the initial charge-discharge efficiency.

In the evaluation of the load characteristic, the discharge capacity obtained in the capacity test was set to 1C capacity, constant current charge was performed at a current value of 1 C at 2.7 V, and then constant voltage charge was performed at 2.7 V until the current density reached 0.05 C to complete charge. Thereafter, the ratio of the 5C discharge capacity to the 1C discharge capacity at the time of discharge at current values of 1C and 5C was regarded as the discharge capacity retention.

Table 1 shows the diameter of the fibrous carbon (hereinafter, referred to as CNT) included in the positive electrode, the particle size of the LCO as a positive electrode active material, the volume content of the CNT, the calculation results of the left side and the right side of Formula (1), and the evaluation results of the battery characteristics in each of Examples 1 to 18.

TABLE 1

| | | LCO | | CNT | | | | | |
|---|---|---|---|---|---|---|---|---|---|
| | CNT | particle | | volume | | | Crack in | | |
| | diameter | size | | content | | | electrode | Discharge | Capacity |
| | (b) | (a) | | (c) | In | A × | after | capacity | retention |
| | nm | um | a/b | vol % | (a/b) | c + B | firing | mAh/g-LCO | % |
| Example 1 | 1.6 | 8.7 | 5438 | 0.24 | 8.60 | 7.06 | Absent | 143 | 83 |
| Example 2 | 1.6 | 8.7 | 5438 | 1.18 | 8.60 | 5.97 | Absent | 143 | 87 |
| Example 3 | 1.6 | 8.7 | 5438 | 2.35 | 8.60 | 4.61 | Absent | 144 | 91 |
| Example 4 | 1.6 | 4.6 | 2875 | 1.18 | 7.96 | 5.97 | Absent | 146 | 92 |
| Example 5 | 1.6 | 4.6 | 2875 | 2.35 | 7.96 | 4.61 | Absent | 146 | 93 |
| Example 6 | 1.6 | 1.1 | 688 | 1.18 | 6.53 | 5.97 | Absent | 115 | 56 |
| Example 7 | 1.6 | 0.56 | 350 | 2.35 | 5.86 | 4.61 | Absent | 103 | 46 |
| Example 8 | 11 | 8.7 | 791 | 1.18 | 6.67 | 5.97 | Absent | 126 | 84 |
| Example 9 | 11 | 8.7 | 791 | 2.35 | 6.67 | 4.61 | Absent | 141 | 87 |
| Example 10 | 11 | 4.6 | 418 | 1.18 | 6.04 | 5.97 | Absent | 141 | 87 |
| Example 11 | 11 | 4.6 | 418 | 2.35 | 6.04 | 4.61 | Absent | 143 | 89 |
| Example 12 | 11 | 4.6 | 418 | 3.50 | 6.04 | 3.28 | Absent | 145 | 91 |
| Example 13 | 11 | 1.1 | 100 | 2.35 | 4.61 | 4.61 | Absent | 106 | 45 |
| Example 14 | 11 | 0.56 | 51 | 3.50 | 3.93 | 3.28 | Absent | 93 | 32 |
| Example 15 | 77 | 8.7 | 113 | 2.35 | 4.73 | 4.61 | Absent | 138 | 85 |
| Example 16 | 77 | 4.6 | 60 | 3.50 | 4.09 | 3.28 | Absent | 144 | 90 |
| Example 17 | 77 | 1.1 | 14 | 4.63 | 2.66 | 1.96 | Absent | 92 | 41 |
| Example 18 | 77 | 0.56 | 7 | 4.63 | 1.98 | 1.96 | Absent | 94 | 33 |

As shown in Table 1, in each of Examples 1 to 18, a coin cell secondary battery was formed in accordance with (Method for manufacturing secondary battery) described above, and the capacity test and the load characteristic were evaluated. In Examples 1 to 18, the kind (diameter) of the CNT, the amount (volume content) of the added CNT, and the particle size of the LCO were varied, and thus each positive electrode green sheet was produced.

More specifically, in Examples 1 to 7, the diameter of the CNT is 1.6 nm, the particle size of the LCO is varied to be 8.7 μm, 4.6 μm, 1.1 μm, or 0.56 μm, and the volume content of the CNT is varied in the range from 0.24 vol % to 2.35 vol %.

In Examples 8 to 14, the diameter of the CNT is 11 nm, the particle size of the LCO is varied to be 8.7 μm, 4.6 μm, 1.1 μm, or 0.56 μm, and the volume content of the CNT is varied in the range from 1.18 vol % to 3.50 vol %. Examples 8 to 14 include Examples in which the diameter of the CNT is larger and the volume content of the CNT is larger than those in Examples 1 to 7.

In Examples 15 to 18, the diameter of the CNT is 77 nm, the particle size of the LCO is varied to be 8.7 μm, 4.6 μm, 1.1 μm, or 0.56 μm, and the volume content of the CNT is varied in the range from 2.35 vol % to 4.63 vol %. Examples 15 to 18 include Examples in which the diameter of the CNT is larger and the volume content of the CNT is larger than those in Examples 1 to 14.

Table 1 shows the ratio (a/b) of the diameter of the CNT to the particle size (a) of the LCO, In (a/b), which is the left side of Formula (1) described above, and A×c+B (wherein A=−116.12 and B=7.3384), which is the right side of Formula (1) in each of Examples 1 to 18. In each of Examples 1 to 15, the diameter (b) of the CNT of the positive electrode, the particle size (a) of the LCO, and the volume content (c) of the CNT satisfy Formulas (1) and (2). In Formula (2), more specifically, the volume content of the CNT is in the range of more than 0.2 vol % and less than 4.7 vol %. The diameter (b) of the CNT is, for example, 80 μm or less.

In each of Examples 1 to 18, no crack was caused in the electrodes after firing. In the evaluation results of the battery characteristics, as the diameter (b) of the CNT is smaller and the volume content (c) of the CNT is smaller, the discharge capacity and the capacity retention tended to be higher, and better electrochemical characteristics were exhibited. This is considered to be because the presence of the CNT along the surface of the LCO as a positive electrode active material improves the electrical contact and increase the retention of the active material in the network structure.

Meanwhile, in a case where the particle size (a) of the LCO is 1.1 μm or 0.56 μm after pulverization for 20 hours or more (Examples 6, 7, 13, 14, 17, 18), the discharge capacity and the discharge retention are lower than in Examples in which the particle size is 4.6 μm or 8.7 μm. As shown in Comparative Examples 10 to 13 described below, a similar tendency was observed in a coated electrode in which the same active material was used, and therefore this is presumed to be because excessive pulverization treatment changes the crystal structure of the LCO surface to cause a resistance phase.

That is, in Examples 1 to 18, more preferably, in a range such that the diameter (b) of the CNT is 11 nm or less and the particle size (a) of the LCO is 4.6 μm or more, a good discharge capacity and a good capacity retention were obtained.

### Comparative Example

Next, Comparative Examples will be described. Like Table 1, Table 2 shows the diameter of the CNT, the particle size of the LCO as a positive electrode active material, the volume content of the CNT, the calculation results of the left side and the right side of Formula (1), and the evaluation results of the battery characteristics in each of Comparative Examples 1 to 13. In the battery of each of Comparative Examples 1, 11, 12, and 13 having no description of the diameter of the CNT and the volume content of the CNT in Table 2, no CNT is added to the positive electrode. In the battery of Comparative Example 2, a positive electrode to which no CNT is added (having a volume content of the CNT of 0.00 volt) is used. In the battery of each of Comparative Examples 2 to 10 having no description of evaluation results of the battery characteristics, evaluation of the battery characteristics was impossible due to cracks in the electrodes after firing.

TABLE 2

| | | LCO | | CNT | | | | | |
|---|---|---|---|---|---|---|---|---|---|
| | CNT | particle | | volume | | | Crack in | | |
| | diameter | size | | content | | | electrode | Discharge | Capacity |
| | (b) | (a) | | (c) | In | A × | after | capacity | retention |
| | nm | um | a/b | vol % | (a/b) | c + B | firing | mAh/g-LCO | % |
| Comparative | — | 8.7 | — | — | — | — | Absent | 144 | 71 |
| Example 1 | | | | | | | | | |
| Comparative | 1.6 | 8.7 | 5438 | 0.00 | 8.60 | 7.34 | Present | — | — |
| Example 2 | | | | | | | | | |
| Comparative | 1.6 | 8.7 | 5438 | 0.19 | 8.60 | 7.12 | Present | — | — |
| Example 3 | | | | | | | | | |
| Comparative | 11 | 8.7 | 791 | 0.24 | 6.67 | 7.06 | Present | — | — |
| Example 4 | | | | | | | | | |
| Comparative | 11 | 4.6 | 418 | 0.24 | 6.04 | 7.06 | Present | — | — |
| Example 5 | | | | | | | | | |
| Comparative | 11 | 1.1 | 100 | 1.18 | 4.61 | 5.97 | Present | — | — |
| Example 6 | | | | | | | | | |
| Comparative | 11 | 0.56 | 51 | 1.18 | 3.93 | 5.97 | Present | — | — |
| Example 7 | | | | | | | | | |
| Comparative | 77 | 8.7 | 113 | 1.18 | 4.73 | 5.97 | Present | — | — |
| Example 8 | | | | | | | | | |
| Comparative | 77 | 1.1 | 14 | 3.50 | 2.66 | 3.28 | Present | — | — |
| Example 9 | | | | | | | | | |
| Comparative | 77 | 0.56 | 7 | 3.50 | 1.98 | 3.28 | Present | — | — |
| Example 10 | | | | | | | | | |
| Comparative | — | 4.6 | — | — | — | — | Absent | 143 | 63 |
| Example 11 | | | | | | | | | |
| Comparative | — | 1.1 | — | — | — | — | Absent | 83 | 29 |
| Example 12 | | | | | | | | | |
| Comparative | — | 0.56 | — | — | — | — | Absent | 72 | 23 |
| Example 13 | | | | | | | | | |

### Comparative Examples 1, 11, 12, and 13

In each of Comparative Examples 1, 11, 12, and 13 shown in Table 2, the positive electrode and the negative electrode are formed by coating, and unlike each of Examples described above, a firing step is not included. In each of Comparative Examples 1, 11, 12, and 13, a positive electrode including no CNT is used, and therefore the diameter of the CNT and the volume content of the CNT are not described in Table 2. Hereinafter, the steps of manufacturing the coated electrodes and the cells of Comparative Examples 1, 11, 12, and 13 will be described.

### Production of Negative Electrodes of Comparative Examples 1, 11, 12, and 13

With a rotation-revolution mixer, 17.5 g of an LTO powder (manufactured by ISHIHARA SANGYO KAISHA, LTD.) as a raw material powder of a negative electrode, 0.921 g of polyvinylidene fluoride (PVDF) as a binder, and NMP as a solvent were mixed at 2000 rpm for 3 minutes. The obtained mixture was additionally stirred at 2000 rpm for 30 seconds and defoamed at 2200 rpm for 30 seconds to obtain an LTO slurry.

The LTO slurry was applied onto an aluminum foil (thickness: 12 μm) with an applicator and an automatic coater, and dried in an oven at 80° C. for 40 minutes, and subsequently at 120° C. for 20 minutes. The dried coating film was punched out with a 15 mm diameter punching machine to form a coated LTO electrode.

### Production of Positive Electrodes of Comparative Examples 1, 11, 12, and 13

In a 150 mL plastic container, 23.5 g of an LCO powder (manufactured by Umicore) as a raw material powder of a positive electrode, 0.758 g of polyvinylidene fluoride (PVDF) as a binder, 0.05 g of carbon black as a conductive agent, and NMP as a solvent were weighed out and mixed with a rotation-revolution mixer at 2000 rpm for 3 minutes. The obtained mixture was additionally stirred at 2000 rpm for 30 seconds and defoamed at 2200 rpm for 30 seconds to obtain an LCO slurry.

The LCO slurry was applied onto an aluminum foil (thickness: 12 μm) with an applicator and an automatic coater, and dried in an oven at 80° C. for 40 minutes, and subsequently at 120° C. for 20 minutes. The dried coating film was punched out with a 15 mm diameter punching machine to form a coated LCO electrode.

### Production of Batteries of Comparative Examples 1, 11, 12, and 13

A coin cell was produced, in the same manner as in (Production of battery) in an embodiment described above, using the coated LCO electrode as a positive electrode, the coated LTO electrode as a negative electrode, and a polyethylene (PE) porous film as a separator.

As shown in Table 2, in Comparative Examples 1, 11, 12, and 13 in which coated electrodes are used, a firing step is not included, and therefore no crack is caused in the electrodes. The capacity retention in each of Comparative Examples 1, 11, 12, and 13 in which coating electrodes are used shows a lower value than those in Examples shown in Table 1. In a case where the particle size (a) of the LCO is 1.1 μm or 0.56 μm (Comparative Examples 12 and 13), the discharge capacity and the discharge retention are lower than in Comparative Examples 1 and 11 in which the particle size is 4.6 μm or 8.7 pm. The values of the discharge capacity in Comparative Examples 12 and 13 are lower than in Examples 6 and 7 in which the particle sizes (a) of the LCO are the same as those in Comparative Examples 12 and 13, respectively.

### Comparative Example 2

In Comparative Example 2, a battery was produced using a positive electrode to which no CNT was added (having a volume content of the CNT of 0.00 vol %). Except for the use of such a positive electrode, the method for manufacturing a battery is the same as in (Method for manufacturing secondary battery) in an embodiment described above.

### Production of Positive Electrode Green Sheet Including No CNT

In a 150 mL plastic container, 23.5 g of an LCO powder (manufactured by Umicore, D50=10 μm) as a raw material powder of the positive electrode 21, 0.875 g of PVB (manufactured by SEKISUI CHEMICAL CO., LTD., product number BM-2) as a binder, 0.2125 g of DOP (manufactured by Tokyo Chemical Industry Co., Ltd.) as a plasticizer, and 5 g of NMP as a solvent were weighed out and mixed with a rotation-revolution mixer at 2000 rpm for 3 minutes. The obtained mixture was additionally stirred at 2000 rpm for 30 seconds and defoamed at 2200 rpm for 30 seconds to obtain an LCO slurry.

The LCO slurry was applied onto a PET film having a release agent on one side (manufactured by TOYOBO Co., Ltd., product number E7007) with an applicator and an automatic coater, and dried in an oven at 80° C. for 40 minutes, and subsequently at 120° C. for 20 minutes. The dried coating film was peeled off from the PET film, and punched out with a 15 mm diameter punching machine to form a positive electrode green sheet.

In Comparative Example 2 in which both the positive electrode and the negative electrode include no CNT, cracks were caused in the electrodes after firing, and evaluation of the battery characteristics was impossible.

### Comparative Examples 3 to 10

In Comparative Examples 3 to 10 shown in Table 2, the kind (diameter) of the CNT, the amount (volume content) of the added CNT, and the particle size of the LCO were varied, and thus each positive electrode green sheet was produced. In Comparative Examples 3 to 10, the diameter (b) of the CNT of the positive electrode, the particle size (a) of the LCO, and the volume content (c) of the CNT are different from those in Examples in Table 1, and except for the above conditions, the method for manufacturing a battery is the same as in (Method for manufacturing secondary battery) in an embodiment described above.

More specifically, in Comparative Example 3, the diameter of the CNT is 1.6 nm, the particle size of the LCO is 8.7 μm, and the volume content of the CNT is 0.19 vol %. In Comparative Examples 4 to 7, the diameter of the CNT is 11 nm, the particle size of the LCO is varied to be 8.7 μm, 4.6 μm, 1.1 μm, or 0.56 μm, and the volume content of the CNT is varied to be 0.24 vol % or 1.18 vol %.

In Comparative Examples 8 to 10, the diameter of the CNT is 77 nm, the particle size of the LCO is varied to be 8.7 μm, 1.1 μm, or 0.56 μm, and the volume content of the CNT is varied to be 1.18 vol % or 3.50 vol %.

In each of Comparative Examples 3 to 10, the diameter (b) of the CNT of the positive electrode, the particle size (a) of the LCO, and the volume content (c) of the CNT do not satisfy at least one of Formula (1) or (2). Specifically, in Comparative Example 3 (and Comparative Example 2), Formula (1) is satisfied, but the volume content (c) of the CNT is 0.2 vol % or less and is out of the range of Formula (2). In Comparative Examples 4 to 10, Formula (2) is satisfied, but the value of In (a/b) is A×c+B (wherein A=−116.12 and B=7.3384) or less and is out of the range of Formula (1).

As shown in Table 2, in each of Comparative Examples 3 to 10, the positive electrode was out of the ranges of Formula (1) and Formula (2) although including the CNT, and cracks were caused in the electrodes after firing, so that evaluation of the battery characteristics was impossible.

As described above, in each of Examples shown in Table 1, at least one of the positive electrode or the negative electrode (in Examples, the positive electrode) included the active material (LCO) and the fibrous carbon (CNT), and the diameter (b) of the CNT of the positive electrode, the particle size (a) of the LCO, and the volume content (c) of the CNT were set within the ranges such that Formulas (1) and (2) were satisfied, and as a result, it has been shown that occurrence of a crack in the electrodes after firing can be suppressed as compared with Comparative Examples 2 to 10. Furthermore, in each of Examples shown in Table 1, better electrochemical characteristics were exhibited than in the coated electrodes of Comparative Examples 1, 11, 12, and 13.

In each Example, the internal stress generated by shrinkage during firing of the electrode laminate is alleviated by slip in the point contact of the CNTs forming the bridge structure, and thus occurrence of a crack in the electrodes after firing is suppressed. Furthermore, it has been shown that in the fired electrode of each Example, the absence of an organic binder as a resistance component promotes movement of ions to achieve a low-resistance battery.

Note that the values of the diameter (b) of the CNT of the positive electrode, the particle size (a) of the LCO, the volume content (c) of the CNT, and the like shown in Examples and Comparative Examples described above are merely examples, and the present application is not limited thereto. The method for manufacturing a secondary battery in an embodiment and the manufacturing methods shown in Examples and Comparative Examples are also merely examples, and the present application is not limited thereto.

In an embodiment, the configuration of the secondary battery 1 as an electrochemical device is described, but the configuration is merely an example, and the present application is not limited to the configuration. The present disclosure can also be applied to, for example, a capacitor, a fuel cell, and the like as an electrochemical device. Furthermore, the configuration of a coin or button battery as the secondary battery 1 is described, but the present application is not limited to the configuration. The secondary battery 1 of the present disclosure may be, for example, a cylindrical or a laminate film battery.

It is to be noted that an embodiment described above are intended to facilitate understanding of the present application, but not intended to construe the present application in any limited way. The present application can be modified or improved without departing from the purpose, and equivalents are also included in the present application.

### DESCRIPTION OF REFERENCE SYMBOLS

1: Secondary battery
21: Positive electrode
22: Negative electrode
23: Separator
31: Positive electrode active material
32: Fibrous carbon
100: Electrode laminate

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An electrochemical device comprising:
a positive electrode;
a negative electrode;
a separator; and
an electrolyte,
wherein at least one of the positive electrode or the negative electrode includes first active material particles and fibrous carbon,
the first active material particles are retained in a bridge structure formed by the fibrous carbon,
the separator includes insulating inorganic particles and an inorganic binder that bonds the insulating inorganic particles together,
the electrolyte includes a nonaqueous solvent and a supporting salt,
the positive electrode, the negative electrode, and the separator are impregnated with the electrolyte, and
the separator and at least one of the positive electrode or the negative electrode are bonded together by the inorganic binder.

2. The electrochemical device according to claim 1, wherein
at least one of the positive electrode or the negative electrode satisfies Formulas (1) and (2) described below:
$$ln ( a / b ) > - 116.12 \times c + 7.3384 \qquad ( 1 )$$
$$c > 0.2 \qquad ( 2 )$$
wherein a represents a particle size (D50) of the first active material particles, b represents a diameter of the fibrous carbon, and c represents a volume content of the fibrous carbon.

3. The electrochemical device according to claim 1, wherein
one of the positive electrode and the negative electrode includes the first active material particles and the fibrous carbon, and
another of the positive electrode and the negative electrode includes second active material particles, and the second active material particles are bonded together.

4. The electrochemical device according to claim 1, wherein the fibrous carbon has a diameter of 80 μm or less.
